(19) United States
(12) Patent Application Publication
(10) Pub. No.: US 2004/0265446 A1
(43) Pub. Date: Dec. 30, 2004

(54) Microbiocidal control in the processing of poultry

(76) Inventor: James L. McNaughton, Quantico, MD (US)

Correspondence Address: SIEBERTH & PATTY, 2924 BRAKLEY DRIVE SUITE A 1, BATON ROUGE, LA, 70816

(21) Appl. No.: 10/603,132

(22) Filed: Jun. 24, 2003

(51) Int. Cl. A23K 1/00

(52) U.S. Cl. 426/332

(57) ABSTRACT

An opened eviscerated carcass is subjected to inside-outside washing (IOBW) with water treated with at least one 1,3-dibromo-5,5-dialkylhydantoin (DBDAH). Preferably, water treated with at least one DBDAH is brought into contact with a defeathered poultry carcass before the carcass has been opened, and after a period of time during which the carcass remains wet with treated water thereon, the carcass is opened and eviscerated. Then the opened, eviscerated carcass is subjected to IOBW with water treated with DBDAH. Preferably, after the IOBW treatment, the carcass is subsequently subjected to chilling in a chill tank in which water treated with DBDAH is employed as the chilling medium. Optionally, but preferably, the chilled carcass is washed before packaging by a spray with and/or immersion in water treated with DBDAH. These procedures provide very effective microbiocidal control and do not adversely affect the appearance, quality, or taste of the poultry meat product.

### REFERENCE TO COPENDING APPLICATIONS

Reference is hereby made to U.S. application Ser. No. 10/029,329, filed Dec. 21, 2001, and to U.S. application Ser. No. 10/028,631, filed Dec. 21, 2001 (presently owned by one of the two joint owners of the present application), both of which Applications are continuations-in-part of application Ser. No. 09/893,581, filed Jun. 28, 2001, now abandoned, and to U.S. application Ser. No. 10/313,245, filed Dec. 6, 2002, which is a continuation-in-part of commonly-owned copending U.S. application Ser. No. 10/029,329, filed Dec. 21, 2001, which in turn is a continuation-in-part of commonly-owned copending application Ser. No. 09/893,581, filed Jun. 28, 2001, now abandoned. Application Ser. No. 10/029,329 is owned by another party, and application Ser. No. 10/028,631 is presently owned by one of the two joint owners of the present application. Reference is also hereby made to PCT International Application No. PCT/US02/41479, filed Dec. 26, 2002, which is also presently owned by one of the two joint owners of the present application, in which the United States is one of the designated countries or regions, and to U.S application Ser. No. ______ [Case SU-7275______], filed _[contemporaneously herewith]_ (presently owned by that other party). Three of these applications relate, inter alia, to use of 1,3-dibromo-5,5-dialkylhydantoins as treating agents for water used in the field of animal processing, while the fourth application relates, inter alia, to use of 1,3-dihalo-5,5-dialkylhydantoins other than 1,3-dibromo-5,5-dialkylhydantoins as treating agents for water used in the field of animal processing.

### BACKGROUND

Contamination of poultry meat products with various pathogens such as species of Listeria, Escherichia, Salmonella, Campylobacter, and others, is a problem that has existed for many years. While various other microbiocidal materials have been investigated for efficacy, the principal antimicrobial substances used in actual practice in poultry processing operations have been sodium hypochlorite and calcium hypochlorite, largely because of their low cost and ready availability.

A need exists for a way of providing more effective microbiocidal control in the processing of poultry than is possible with use of sodium hypochlorite or calcium hypochlorite.

This invention is deemed to fulfill this need. It does so efficiently and economically.

### BRIEF SUMMARY OF THE INVENTION

Pursuant to one embodiment of this invention, an opened eviscerated carcass is subjected to inside-outside washing with microbiocidal composition used pursuant to this invention. This washing can be effected by immersion in an aqueous solution of the microbiocide or by use of exterior spraying wherein at least a portion of the spray is directed so that it enters the interior cavity of the carcass. Preferably however, the carcass is subjected to inside-outside washing by use of an inside-outside bird washing (IOBW) apparatus wherein, in addition to exterior washing with a solution of the microbiocide typically applied by a spray delivery system such as a series or array of nozzles, a spray delivery system such as a probe or bayonet enters the interior cavity and applies therein a pressurized spray of the treated water to the interior cavity of the carcass.

Pursuant to another embodiment of this invention, water treated with a microbiocidal composition used pursuant to this invention is brought into contact with the defeathered poultry carcass before the carcass has been opened. After a period of time during which carcass remains wet with treated water thereon, the carcass is opened and eviscerated and the opened, eviscerated carcass is subjected to inside-outside washing with microbiocidal composition used pursuant to this invention, again preferably by use of an inside-outside bird washing (IOBW) apparatus.

Pursuant to a further embodiment of this invention, an opened, eviscerated poultry carcass is subjected to inside-outside washing with water treated with a microbiocidal composition used pursuant to this invention, again preferably by use of an inside-outside bird washing (IOBW) apparatus, and thereafter the carcass is placed in a chill tank and brought into contact with chill water treated with a microbiocidal composition used pursuant to this invention for a period of time that is at least sufficient for the carcass to reach a pre-selected low temperature.

Pursuant to another preferred embodiment of this invention, effective microbiocidal control in the processing of poultry is brought about by use of a highly effective biocidal composition in at least three specific, highly important poultry processing stages or stations, whereby without materially affecting productivity, more effective microbiocidal control is achieved as compared to use of the hypochlorite microbiocides. Indeed, this embodiment of the invention makes it possible to minimize individual plant off-line reprocessing operations.

More particularly, pursuant to this preferred embodiment of this invention water treated with a microbiocidal composition used pursuant to this invention is brought into contact with the defeathered poultry carcass before the carcass has been opened. Such contact can be brought about for example by applying to the exterior of the unopened defeathered carcass, a spray of the water treated with the microbiocidal composition or the unopened defeathered carcass can be placed into contact with a body of water which has been treated with the microbiocidal composition, such as by use of a drag tank containing such treated water. After a period of time during which the unopened defeathered carcass remains wet with treated water thereon, the carcass is opened and eviscerated. Then the opened and eviscerated carcass is introduced into an inside-outside bird washer wherein water treated with a microbiocidal composition used pursuant to this invention is brought into contact with the interior and the exterior of the bird, most preferably by use of inside-outside bird washing apparatus (IOBW). Thereafter the carcass is placed in a chill tank and brought into contact with chill water treated with a microbiocidal composition used pursuant to this invention for a period of time that is at least sufficient for the carcass to reach a pre-selected low temperature. In an especially preferred embodiment, before packaging such carcass for sale, the carcass is again brought into contact with water treated with a microbiocidal composition used pursuant to this invention.

The microbiocidal compositions used in the practice of the various embodiments of this invention are one or more 1,3-dibromo-5.5-dialkylhydantoins. Preferably the one or more 1,3-dibromo-5.5-dialkylhydantoins are the sole sources of microbiocidal activity in the water treated therewith. However this invention includes use in the above operations of water treated with one or more 1,3-dibromo-5.5-dialkylhydantoins and one or more other microbiocidal agents that are compatible therewith.

These and other embodiments and features of this invention will be still further apparent from the ensuing description and appended claims.

### FURTHER DETAILED DESCRIPTION OF THE INVENTION

In each of the embodiments of this invention substantial benefits are achieved by the use of aqueous microbiocidal solutions formed from one or more 1,3-dibromo-5.5-dialkylhydantoins. Besides being more effective on an equal halogen basis than other halogen-containing biocidal agents such as hypochlorite, the 1,3-dibromo-5.5-dialkylhydantoins are less corrosive to the nozzles, fittings, cabinets, transporting apparatus, and other parts of the washing systems used. Moreover, because of their greater effectiveness as antimicrobials, the 1,3-dibromo-5.5-dialkylhydantoins such as 1,3-dibromo-5,5-dimethylhydantoin can be employed at suitably low concentrations in water.

In the processing of poultry for consumption as a meat product, this invention comprises in one of its embodiments causing an eviscerated poultry carcass, preferably a mechanically transported series of poultry carcasses, to be subjected to inside-outside washing with water treated with a microbiocidal amount of at least one 1,3-dibromo-5,5-dialkylhydantoin.

While hand spraying equipment can be used, it is preferred to conduct the inside-outside bird washing (IOBW) with apparatus that is adapted to conduct these operations automatically and thoroughly. One such type of apparatus is referred to in U.S. Pat. No. 4,849,237, issued Jul. 18, 1989 wherein carcasses are transported through a trough in which the carcasses can be fully immersed in a cleansing liquid and wherein rows of nozzles along the bottom are directed to stream jets of cleansing liquid into the inner body cavity of the carcasses. However, for this purpose it is most preferred to employ apparatus in which an inside spray probe penetrates the neck cavity from the body cavity or that creates a positive opening in the neck so that the aqueous cleansing solution used pursuant to this invention together with contaminants readily drain from the suspended carcass as it is conveyed through the apparatus. Such preferred apparatus will also apply pressurized sprays of the aqueous microbiocidal solution to the exterior of the suspended carcass by means of a manifold or array of spray nozzles so that the exterior of the carcass is also thoroughly cleansed. The exterior of the carcass can be scrubbed by brushes or other flexible scrubbing surfaces as it leaves the apparatus. See for example the apparatus described in U.S. Pat. No. 5,482,503, issued Jan. 9, 1996. Typical apparatus which can be used for such preferred inside-outside bird washing is available from Johnson Food Equipment, Inc. (a member of the Baader Group), 2955 Fairfax Trafficway, Kansas City, Kans. 66115, Telephone 913-621-3366, Web Site www.baader.johnson.com (e.g., Birdwasher 10505-16 with a current indicated capacity of up to 100 birds per minute or Birdwasher 10505-20 with a current indicated capacity of up to 140 birds per minute); and from Cantrell Machine Co., Inc. P.O. Box 757 1400 S. Bradford Street Gainsville, Ga. 30503, Telephone 770-536-3611, Web Site www.cantrell.com (e.g., Inside/Outside Bird Washer Model No. FIO-515 with a current indicated capacity as a 14 unit machine of 5600 birds per hour).

In another embodiment of this invention in the processing of poultry for consumption as a meat product, this invention comprises the following improvements:

a) causing (i) at least one defeathered poultry carcass, preferably a mechanically transported series of defeathered unopened poultry carcasses, and (ii) water treated with a microbiocidal amount of at least one 1,3-dibromo-5,5-dialkylhydantoin, to come into contact with each other, whereby the exterior of the at least one carcass is, or the exterior carcasses of the series of carcasses are, wetted by such water for a period of time sufficient to provide microbiocidal activity on the wet exterior(s) of the carcass(es);

b) opening and eviscerating the carcass(es) that has been or have been wetted in a);

c) causing a eviscerated poultry carcass, preferably a mechanically transported series of poultry carcasses, to be subjected to inside-outside washing with water treated with a microbiocidal amount of at least one 1,3-dibromo-5,5-dialkylhydantoin.

A preferred embodiment in the processing of poultry for consumption as a meat product comprises the following improvements:

a) causing (i) water treated with a microbiocidal amount of at least one 1,3-dibromo-5,5-dialkylhydantoin and (ii) at least one defeathered poultry carcass to come into contact with each other before the carcass is opened, whereby the carcass exterior is wetted by such water for a period of time sufficient to provide microbiocidal activity of the wet exterior of the carcass via either spraying or washing;

b) opening and eviscerating the carcass that was wetted in a);

c) causing the eviscerated carcass to be subjected to inside-outside washing with water treated with a microbiocidal amount of at least one 1,3-dibromo-5,5-dialkylhydantoin;

d) causing the carcass that was washed in c) to be placed in a chill tank and brought into contact with chill water treated with a microbiocidal amount of at least one 1,3-dibromo-5,5-dialkylhydantoin, said carcass being in said chill water for a period of time that is at least sufficient for the carcass to reach a preselected low temperature;

e) causing the chilled carcass to be removed from the chill water; and optionally but preferably

f) before packaging the chilled carcass, causing (i) the chilled carcass and (ii) water treated with a microbiocidal amount of at least one 1,3-dibromo-5,5-dialkylhydantoin to come into contact with each other.

As above, this preferred embodiment is more preferably applied to mechanically transported series of poultry carcasses. It can be seen that in at least three stages or stations of this preferred embodiment, viz., a), c), and d), and preferably in f) as well, the carcass is sanitized by contact with water treated with at least one 1,3-dibromo-5,5-dialkylhydantoin. Yet, despite the fact that the carcass is sanitized in three or four stages during the overall process, the taste, appearance, and quality of the finished product are not adversely affected in any significant manner.

The multiple contacting or washing operations when used pursuant to this invention ensure that pathogens such as species of Listeria, Escherichia, Salmonella, Campylobacter, and others, are effectively controlled, if not essentially eliminated from the meat product. Moreover, in large scale bird processing lines where high throughput is essential, the microbiocide used in these stages or stations is so effective that it is not necessary to slow down the line to give the microbiocide time to act. Thus the processing lines can be operated at conventional speeds, if not at increased speeds. Further, the waters used in the respective stages or stations can each be treated with suitable microbiocidal quantities of a given 1,3-dibromo-5,5-dialkylhydantoin microbiocidal agent and thus only one such agent can be used throughout the plant, thus simplifying the purchasing, storage and inventory aspects of the plant operation. Indeed it is possible to use water containing the same microbiocidal concentration of the one or more 1,3-dibromo-5,5-dialkylhydantoins in the water going to each of stages a), c), and d), and also in f) as well.

Referring more particularly to the preferred embodiments wherein three or four stages involves washing with water treated with at least one 1,3-dibromo-5,5-dialkylhydantoin. In stage a), the bird carcasses to be treated in the process have already been defeathered upline by means of conventional processing including use of a scalding tank or trough, after which the carcass is typically picked and in some cases singed. In typical automated processing lines, the time for the defeathered carcass to travel from the defeathering stage to the carcass opening and evisceration stage is often in the range of about 20-240 seconds, and this is ample time for the washing treatment of this invention to effectively sanitize the exterior of the carcass. This washing or spraying treatment of the invention can involve use of sprays such as by-conveying the carcasses through a spraying station or cabinet where the water treated pursuant to this invention is applied to thoroughly wet the carcasses. Other ways of conducting this washing treatment include immersion of the defeathered carcasses in a bath of water treated pursuant to this invention, and this can involve, for example, conveying the suspended unopened carcasses through the bath.

In conducting the washing in stage a) of this invention, the water used, typically at a temperature of about 5 to about 30° C. is treated with at least one 1,3-dibromo-5,5-dialkylhydantoin microbiocidal agent in an amount to achieve a bromine residual in the range of about 3 to about 150 ppm (wt/wt) as free bromine, and preferably in the range of about 50 to about 100 ppm (wt/wt) as free bromine. It is not necessary to further rinse the unopened carcass before reaching the carcass opening and evisceration stage. However, a rinse with clear water before opening the carcass can be used if desired.

Stage or station b) involves opening, dismembering, and eviscerating the carcass that was wetted in stage or station a). The steps of opening, dismembering, and eviscerating the carcass can include the removal of at least the head and feet from the carcass, and can be conducted in various sequences. Apparatus for conducting the operation is available from various sources and is widely used in commercial installations.

The inside-outside washing of stage c) can be effected by use of hand operated sprayers. In the typical more highly automated processing plants the washing in c) is effected by use of inside-outside washing apparatus through which the carcass is conveyed. Both the interior cavity and the exterior of the eviscerated carcass are washed with sprays, streams, and/or floods of water. Such interior and exterior washings can be conducted sequentially or concurrently. Here again, apparatus for conducting this overall operation is available in the marketplace and is widely used in commercial installations.

In conducting the inside-outside washing pursuant to this invention the water is treated with at least one 1,3-dibromo-5,5-dialkylhydantoin microbiocidal agent in an amount to achieve a bromine residual in the range of about 3 to about 150 ppm (wt/wt) as free bromine, and preferably in the range of about 50 to about 100 ppm (wt/wt) as free bromine. The treated water is typically used at a temperature of about 5 to about 39° C., but can be used at higher temperatures, e.g., up to about 43° C., if desired. Preferred washing apparatus comprises a spray delivery system such as a probe or bayonet which pursuant to this invention applies a pressurized spray of the treated water to the interior cavity of the carcass and another spray delivery system such as a series of nozzles, which system applies the treated water to the exterior of the carcass. In particularly preferred embodiments of this invention the treated water applied by the spray delivery system to the interior cavity of the carcass is treated with a higher concentration of 1,3-dibromo-5,5-dialkylhydantoin(s) than the concentration of the 1,3-dibromo-5,5-dialkylhydantoin(s) used in the treated water applied by the spray delivery system to the exterior the carcass. The 1,3-dibromo-5,5-dialkylhydantoin(s) used for forming the treated water used for washing the interior cavity of the carcass and the 1,3-dibromo-5,5-dialkylhydantoin(s) used for forming the treated water used for forming the treated water for washing the exterior of the carcass can be, and usually will be, of the same chemical composition. However, 1,3-dibromo-5,5-dialkylhydantoin(s) of different chemical composition can be used for forming these respective treated waters for the inside-outside washing.

Before the reaching the chiller treatment in stage d), the carcass that has been subjected to inside-outside washing can be subjected to further decontamination in stage c), such as further spray rinsing in which water treated pursuant to this invention at levels of 1,3-dibromo-5,5-dialkylhydantoin(s) as used to treat the water in the inside-outside washing is applied at suitable pressures by fixed or articulating nozzles. Such rinsing can be accompanied by use of rotary brushes or other ways of increasing contact such as use of ultrasonic energy. Thereafter the carcass can be rinsed with clear water, if deemed necessary or desirable.

In stage d) the carcass that has been washed in c) is placed in a chill tank and brought into contact in the tank with chill water treated with a microbiocidal amount of at least one 1,3-dibromo-5,5-dialkylhydantoin. The water in the chill tank can be fresh or recirculated water, or a combination of both. The recirculated water should be effectively purged of residual impurities from prior usage. Whatever its source, the chill water is treated with a microbiocidally effective amount of at least one 1,3-dibromo-5,5-dialkylhydantoin. Typically the amount of 1,3-dibromo-5,5-dialkylhydantoin(s) used in treating this water is such as to achieve a bromine residual in the range of about 2 to about 150 ppm (wt/wt) as free bromine and preferably in the range of about 15 to about 50 ppm (wt/wt) as free bromine. The temperature of the chill water should be sufficiently low and the residence time of the carcass in the chill water should be sufficient to result in the carcass reaching a temperature in the range of 0 to 7° C., and preferably in the range of 1 to 5° C. The operation in stage d) can involve immersions in more than one chill tank containing water treated pursuant to this invention, and in such case the dosage levels of the 1,3-dibromo-5,5-dialkylhydantoin(s) can be the same or different in successive chill tanks. Also, the chill tank operations can be supplemented by use of cold sprays of either or both of water treated pursuant to this invention and clear water.

After removal from the chill tank, and after rinsing with cold clear water by immersion or spraying, or both, the carcass can be packaged while chilled for storage or transportation under refrigeration. In a preferred embodiment of this invention, after removal from the chill tank the chilled carcass is again washed in stage f) with water treated with a microbiocidal amount of at least one 1,3-dibromo-5,5-dialkylhydantoin. The bromine residual in aqueous antimicrobial solution a-d used in stage F) is typically in the range of about 3 to about 150 ppm (wt/wt) as free bromine, and preferably in the range of about 50 to about 100 ppm (wt/wt) as free bromine. This treated water should be cold enough so that the temperature of the carcass does not reach room temperature. Then the carcass is washed with clear water by immersion or spraying, or both, and packaged while chilled for storage or transportation under refrigeration.

It will be appreciated that although the carcass proceeds from stage a) to stage d) or from stage a) to stage f) in the progressions indicated above, one or more intervening steps can be carried out as long as the intervening step or steps do not adversely affect the benefits resulting from use of the process technology of this invention. For example, portions of the carcass, such as the legs and/or wings, can be removed at any suitable time and placed between the stages referred to herein. Also, it is not necessary to conduct all the stages of the process without interruption, although it is preferred to operate on a continuous basis to the extent economically feasible in any given poultry processing facility. For example, It is possible after removing the chilled carcass from the chill tank, to wash the chilled carcass with cold clear water and store the washed and dried carcass under refrigeration on site. Later, when it is desired to package the carcass for sale or shipment, this can be done without further treatment pursuant to this invention. Preferably however after such storage the carcass is subjected to a treatment as in stage f) followed by another wash with cold clear water, and then the washed and dried product is packaged.

Suitable methods for determining “bromine residual” are known and reported in the literature. See for example, Standard Methods For the Examination of Water and Wastewater, 18th Edition, 1992, from American Public Health Association, 1015 Fifteenth Street, NW, Washington, D.C. 20005 (ISBN 0-87553-207-1), pages 4-36 and 4-37; Hach Water Analysis Handbook, Third Edition, 1997, by Hach Company, Loveland Colo., especially pages 1206 and 1207, and Handbook of Industrial Water Conditioning, 7th edition, Betz Laboratories, Inc., Trevose, Pa. 19047 (Library of Congress Catalog Card Number: 76-27257), 1976, pages 24-29. While these references typically refer to “chlorine residual”, the same techniques are used for determining “bromine residual”, by taking into account the higher atomic weight of bromine as compared to chlorine.

The term “bromine residual” refers to the amount of bromine species present in the treated water available for disinfection. Residuals can be determined as either “free” or “total” depending upon the analytical test method employed. In the present case, the numerical values for bromine residual have been given herein on a free bromine basis. Such values can be monitored by use of the analytical procedure for “free chlorine” given below. However if desired, the bromine residual could be monitored on a “total bromine” basis by using the analytical procedure for “total chlorine” given below. In either case the numerical values obtained are in terms of chlorine and thus such values are multiplied by 2.25 to obtain the corresponding bromine values. Typically the values on a “total bromine” basis on a given sample will be higher than the values on a “free bromine” basis on the same given sample. The important point to understand is that this invention relates to the bromine residual that is actually present in the treated aqueous medium whether the value is determined by use of the free chlorine test procedure or the total chlorine test procedure, but use of the free chlorine test procedure is recommended.

A standard test for determination of low levels of active halogen is known as the DPD test and is based on classical test procedures devised by Palin in 1974. See A. T. Palin, “Analytical Control of Water Disinfection With Special Reference to Differential DPD Methods For Chlorine, Chlorine Dioxide, Bromine, Iodine and Ozone”, J. Inst. Water Eng., 1974, 28, 139. While there are various modernized versions of the Palin procedures, the recommended version of the test is fully described in Hach Water Analysis Handbook, 3rd edition, copyright 1997. The procedure for “total chlorine” (i.e., active chlorine) is identified in that publication as Method 8167 appearing on page 379, Briefly, the “total chlorine” test involves introducing to the dilute water sample containing active halogen, a powder comprising DPD indicator powder, (i.e., N,N′-diethyldiphenylenediamine, KI, and a buffer). The active halogen species present react(s) with KI to yield iodine species which turn the DPD indicator to red/pink. The intensity of the coloration depends upon the concentration of “total chlorine” species (i.e., active chlorine”) present in the sample. This intensity is measured by a calorimeter calibrated to transform the intensity reading into a “total chlorine” value in terms of mg/L Cl₂. If the active halogen present is active bromine, the result in terms of mg/L Cl₂ is multiplied by 2.25 to express the result in terms of mg/L Br₂ of active bromine.

In greater detail, the DPD test procedure is as follows:

1. To determine the amount of species present in the water which respond to the “total chlorine” test, the water sample should be analyzed within a few minutes of being taken, and preferably immediately upon being taken.

2. Hach Method 8167 for testing the amount of species present in the water sample which respond to the “total chlorine” test involves use of the Hach Model DR 2010 calorimeter. The stored program number for chlorine determinations is recalled by keying in “80” on the keyboard, followed by setting the absorbance wavelength to 530 nm by rotating the dial on the side of the instrument. Two identical sample cells are filled to the 25 mL mark with the water under investigation. One of the cells is arbitrarily chosen to be the blank. To the second cell, the contents of a DPD Total Chlorine Powder Pillow are added. This is shaken for 10-20 seconds to mix, as the development of a pink-red color indicates the presence of species in the water which respond positively to the DPD “total chlorine” test reagent. On the keypad, the SHIFT TIMER keys are depressed to commence a three minute reaction time. After three minutes the instrument beeps to signal the reaction is complete. The blank sample cell is admitted to the sample compartment of the Hach Model DR 2010, and the shield is closed to prevent stray light effects. Then the ZERO key is depressed. After a few seconds, the display registers 0.00 mg/L Cl₂. Then, the blank sample cell used to zero the instrument is removed from the cell compartment of the Hach Model DR 2010 and replaced with the test sample to which the DPD “total chlorine” test reagent was added. The light shield is then closed as was done for the blank, and the READ key is depressed. The result, in mg/L Cl₂ is shown on the display within a few seconds. This is the “total chlorine” level of the water sample under investigation. It is to be noted that the test sample may need to be diluted with halogen demand free water in order for the chlorine measurement to be within the measuring range of the instrument. This dilution will need to be taken into account to determine the actual chlorine level of the sample.

3. One method for measuring free chlorine is the Hach Method 8021. This tests for the amount of species present in the water sample which respond to the “free chlorine” test. This test involves the use of the Hach Model DR 2010 calorimeter. The stored program number for chlorine determinations is recalled by keying in “80” on the keyboard, followed by setting the absorbance wavelength to 530 nm by rotating the dial on the side of the instrument. Two identical sample cells are filled to the 25 mL mark with the water under investigation. One of the cells is arbitrarily chosen to be the blank. The blank sample cell is admitted to the sample compartment of the Hach Model DR 2010, and the shield is closed to prevent stray light effects. Then the ZERO key is depressed. After a few seconds, the display registers 0.00 mg/L Cl₂. Then, the blank sample cell used to zero the instrument is removed from the cell compartment of the Hach Model DR 2010. To the second cell, the contents of a DPD Free Chlorine Powder Pillow are added. This is shaken for 10-20 seconds to mix, as the development of a pink-red color indicates the presence of species in the water which respond positively to the DPD “free chlorine” test reagent. Immediately (within one minute of reagant addition) place the prepared sample into the cell holder. The light shield is then closed as was done for the blank, and the READ key is depressed. The result, in mg/L Cl₂ is shown on the display within a few seconds. This is the “free chlorine” level of the water sample under investigation. It is to be noted that the test sample may need to be diluted with halogen demand free water in order for the chlorine measurement to be within the measuring range of the instrument. The dilution will need to be taken into account when determining the chlorine level of the sample.

As seen from the above, in the practice of this invention bromine-based microbiocidal aqueous solutions of at least one 1,3-dibromo-5,5-dialkylhydantoin are employed in multiple stages. These solutions are formed by dissolving one or more 1,3-dibromo-5,5-dialkylhydantoins in water. Preferred are 1,3-dibromo-5,5-dialkylhydantoins in which one of the alkyl groups is a methyl group and the other alkyl group contains in the range of 1 to about 4 carbon atoms. Thus these preferred biocides comprise 1,3-dibromo-5,5-dimethylhydantoin, 1,3-dibromo-5-ethyl-5-methylhydantoin, 1,3-dibromo-5-n-propyl-5-methylhydantoin, 1,3-dibromo-5-isopropyl-5-methylhydantoin, 1,3-dibromo-5-n-butyl-5-methylhydantoin, 1,3-dibromo-5-isobutyl-5-methylhydantoin, 1,3-dibromo-5-sec-butyl-5-methylhydantoin, 1,3-dibromo-5-tert-butyl-5-methylhydantoin, and mixtures of any two or more of them. Of these biocidal agents, 1,3-dibromo-5-isobutyl-5-methylhydantoin, 1,3-dibromo-5-n-propyl-5-methylhydantoin, and 1,3-dibromo-5-ethyl-5-methylhydantoin are, respectively, preferred, more preferred, and even more preferred members of this group from the cost effectiveness standpoint. Of the mixtures of the foregoing biocides that can be used pursuant to this invention, it is preferred to use 1,3-dibromo-5,5-dimethylhydantoin as one of the components, with a mixture of 1,3-dibromo-5,5-dimethylhydantoin and 1,3-dibromo-5-ethyl-5-methylhydantoin being particularly preferred. The most preferred member of this group of microbiocides is 1,3-dibromo-5,5-dimethylhydantoin. This compound is available in the marketplace under the trade designations XtraBrom™ 111 biocide and XtraBrom™ 111T biocide (Albemarle Corporation). When a mixture of two or more of the foregoing 1,3-dibromo-5,5-dialkylhydantoin biocides is used pursuant to this invention, the individual biocides of the mixture can be in any proportions relative to each other. Minor proportions of mono-N-bromo-5,5-dialkylhydantoin(s) can be present along with the 1,3-dibromo-5,5-dialkylhydantoin(s) but such compositions are not preferred.

Methods for producing 1,3-dibromo-5,5-dialkylhydantoins are known and reported in the literature.

The 1,3-dibromo-5,5-dialkylhydantoin(s) used pursuant to this invention can be blended directly in the water to be used in the various stages referred to herein. For this purpose suitable dispensing devices can be employed that meter into water flowing through the device suitable amounts of the 1,3-dibromo-5,5-dialkylhydantoin(s) microbiocides. Alternatively, predetermined quantities of micronized 1,3-dibromo-5,5-dialkylhydantoin(s) may be added to water in amounts in excess of the final use level, and the resultant concentrate can be further diluted, preferably with agitation, with one or more different amounts of water to form one or more treated water compositions to be used in the respective stages of the process.

Other additives can be used in conjunction with the 1,3-dibromo-5,5-dialkylhydantoin(s) provided the other additive or additives are non-toxic, are compatible with aqueous microbiocidal solutions formed by dissolving the 1,3-dibromo-5,5-dialkylhydantoin(s) in water to form the treated water used pursuant to this invention, and do not otherwise detract from the microbiocidal effectiveness of the treated water in any appreciable manner. By “in conjunction with” is meant that in most cases the other additive component(s) are fed separately into the water being used; e.g., the other additives, if susceptible to oxidation by common oxidants, are not mixed directly with the undissolved 1,3-dibromo-5,5-dialkylhydantoin(s). In general, additives which are compatible with aqueous hypohalite bleach solutions such as certain radical scavengers, chelating agents, pH buffering agents, surfactants, and polymers described in detail in U.S. Pat. No. 6,506,718 may be used, if desired. It is also possible to use one or more wetting agents, hydrotropes, thickeners, defoaming agents, and similar functional additives that meet the above criteria. If used, the amount of each suitable selected additive to be used in conjunction with the 1,3-dibromo-5,5-dialkylhydantoin(s) should be sufficient to provide the property for which it is employed. Recommendations from manufacturers of such other additives are useful as guidlelines in this respect.

Various species of poultry can be processed pursuant to this invention. Non-limiting examples of poultry that can be processed include chicken, rooster, turkey, duck, goose, quail, pheasant, ostrich, game hen, emu, squab, guinea fowl, and Cornish hen.

An end result achievable by the practice of this invention is highly effective minimization of microbiological contamination of the meat product at all stages of the above-specified operations, and the provision of a meat product in which the taste, sensory quality, appearance, and wholesomeness of the product the product are not adversely affected in any material manner by the microbiocidal operations conducted pursuant to this invention. And when properly conducted, this invention makes possible achievement of significantly higher microbial control than achieved with comparable levels of hypochlorite in water. A number of literature references describe suitable methods for testing the qualities of poultry meat products, and any art-recognized procedure can be used to evaluate the taste, sensory quality, appearance, and/or wholesomeness of the product processed pursuant to this invention. One such reference is a paper of A. I. Ikeme, B. Swaminathan, M. A. Cousin, and W. J. Stadelman entitled “Extending the Shelf-Life of Chicken Broiler Meat”, Poultry Science, 1982, 61, 2200-2207.

Although reference is sometimes made above to a “carcass” it is to be understood that in actual operations the process is typically applied to a continuous procession of “carcasses” which are carried on or by conveyor belts which are usually equipped with suitable fastening means. Also, the words “stages” and “stations” are used interchangeably in this description.

The following Example illustrates the advantages achievable by the practice of this invention. The Example is not intended to restrict the scope of the invention to only the procedures described therein.

### EXAMPLE

A study was conducted to determine the effectiveness of 1,3-dibromo-5,5-dimethylhydantoin as a disinfectant, when used in the inside-outside bird washer (IOBW) for the control of carcass bacteria. Comparisons were made to sodium hypochlorite when used under the same test conditions. Commercial poultry IOBW apparatus was simulated. Bacteria were removed from the carcasses using the standard “whole-bird” wash system (Federal Register [Vol. 61, No. 144, Jul. 25, 1996, p. 38921 Pathogen Reduction: Hazard Analysis and Critical Control Point (HACCP) Systems; http://www.fsis.usda.gov/OA/fr/haccp_rule.htm]. The system is used by the poultry industry and USDA to determine whole carcass bacteria counts. Whole bird rinse Escherichia Coli was enumerated and used to demonstrate carcass bacteria reduction due to disinfection.

Nine (9) different treatments were administered with ten (10) carcasses per treatment. In Test Groups 2-5 the microbiocidal agent used was 1,3-dibromo-5,5-dimethylhydantoin (DBDMH). In Test Groups 6-9 the microbiocidal agent used was sodium hypochlorite bleach solution (10-13% label commercial grade). The Cl₂ level was determined on this concentrated solution, and dilutions for the tests were made based on actual Cl₂ concentrations as determined by analysis. Test material inclusion rates were as shown in Table 1. For convenience, concentrations are given in Table 1 (and Table 4 hereinafter) in terms of “ppm Br₂” or “ppm Cl₂”. These are shorthand ways of referring to bromine residuals or chlorine residuals in the water.

TABLE 1

| Treatment | Treatment Identification | Br₂/Cl₂ IOBW Level |
|---|---|---|
| Group | Active Ingredient | Spray Content |
| 1 | Non-disinfected control (no test material added). Carcasses are | None |
| | spotted with 10⁵ total E. Coli bacteria, dried for 25-35 min, and | |
| | sprayed with tap water, and allowed to drip for 30 seconds, then | |
| | immediately rinsed. | |
| 2 | DBDMH (45 ppm Br₂). Carcasses are spotted with 10⁵ total E. Coli | 45 ppm Br₂ |
| | bacteria, dried for 25-35 min, sprayed with Bromine solution, and | |
| | allowed to drip for 30 seconds, then carcasses rinsed immediately. | |
| 3 | DBDMH (75 ppm Br₂). Carcasses are spotted with 10⁵ total E. Coli | 75 ppm Br₂ |
| | bacteria, dried for 25-35 min, sprayed with Bromine solution, and | |
| | allowed to drip for 30 seconds, then carcasses rinsed immediately. | |
| 4 | DBDMH (45 ppm Br₂). Carcasses are spotted with 10⁵ total E. Coli | 45 ppm Br₂ |
| | bacteria, dried for 25-35 min, sprayed with Bromine solution, and | |
| | allowed to drip for 60 seconds, then carcasses rinsed immediately. | |
| 5 | DBDMH (75 ppm Br₂). Carcasses are spotted with 10⁵ total E. Coli | 75 ppm Br₂ |
| | bacteria, dried for 25-35 min, sprayed with Bromine solution, and | |
| | allowed to drip for 60 seconds, then carcasses rinsed immediately. | |
| 6 | Chlorine (20 ppm Cl₂). Carcasses are spotted with 10⁵ total E. Coli | 20 ppm Cl₂ |
| | bacteria, dried for 25-35 min, sprayed with chlorine solution, and | |
| | allowed to drip for 30 seconds, then carcasses rinsed immediately. | |
| 7 | Chlorine (50 ppm Cl₂). Carcasses are spotted with 10⁵ total E. Coli | 50 ppm Cl₂ |
| | bacteria, dried for 25-35 min, sprayed with chlorine solution, and | |
| | allowed to drip for 30 seconds, then carcasses rinsed immediately. | |
| 8 | Chlorine (20 ppm Cl₂). Carcasses are spotted with 10⁵ total E. Coli | 20 ppm Cl₂ |
| | bacteria, dried for 25-35 min, sprayed with chlorine solution, and | |
| | allowed to drip for 60 seconds, then carcasses rinsed immediately. | |
| 8 | Chlorine (50 ppm Cl₂). Carcasses are spotted with 10⁵ total E. Coli | 50 ppm Cl₂ |
| | bacteria, dried for 25-35 min, sprayed with chlorine solution, and | |
| | allowed to drip for 60 seconds, then carcasses rinsed immediately. | |

The bacteria source, characteristics, preparation, and enumeration (stock culture) were as follows:

A) Bacteria Culture Sourcing And Development: Ninety-six (96) hours ±2 hours prior to Time Zero, E. Coli stock cultures, obtained from University of Delaware, were transferred individually into MacConkey Agar media and incubated at 37±2° C. for 24±2 hours, as described in AOAC 965.13. Cultures were removed from agar surfaces with five-mL phosphate buffer dilution water and centrifuged in sterile centrifuge tubes approximately two minutes at speed necessary to settle agar particles. The supernatants after centrifugation was again transferred to sterile centrifuge tubes to obtain complete separation of cells. Fresh MacConkey Agar whole plates were swabbed from the supernatant using sterile swabs. Plates will be incubated for 24±2 hours at 37±2° C. This process was repeated over two additional days.

B) Culture Purification:. From the purification process above, the bacteria culture was inoculated into Nutrient Broth and incubated at 37±2° C. for 24±2 hours.

C) Stationary Bacteria Growth Established: Prior to carcass immersion, culture broth OD during incubation was used to predict incubation time to reach stationary growth of >1.0×10⁹ bacteria count per mL broth. The pre-trial stationary growth (for both bacteria cultures) was established at 14-24 hr incubation time with an OD reading of >1000 formazin turbidity units (or FTU). Based on stationary bacteria growth data, the decision was made to define stationary growth at 18±one hour with at least 1000 FTU. If OD is not reached (i.e., >1000 FTU) at time of spotting, then broth would be grown for an additional time and carcass spraying would be delayed.

D) Broth/Bacteria Dilution and E. coli Source Used: The broth was diluted as necessary to achieve a target of 10⁵ of each bacteria source per mL.

E) Spotting Time: After 18±one hour incubation and >1000 FTU confirmation, bacteria were spotted within 30 minutes after exiting the incubator.

F) Culture Plating Technique: Diluted bacteria stock solution that is spotted was enumerated immediately after spotting. Tube dilution commenced using the tube dilution rate technique, typical for microbiology. Dilution rates for bacteria stock solution were as shown in Table 2:

TABLE 2

| | |
|---|---|
| 1:10,000 (1:10 K) | For each sterile test tube, containing 9 mL |
| 1:100,000 (1:100 K) | sterile water, a one mL sample will be |
| 1:1,000,000 (1:1 M) | withdrawn from the broth and mixed with the |
| 1:10,000,000 (1:10 M) | first tube for a 1:10 dilution. Using a clean |
| 1:100,000,000 (1:100 M) | pipette tip, one mL from each tube will be |
| 1:1,000,000,000 (1:1 B) | added to others in the same manner for |
| | 10-fold dilutions until 1:1,000,000,000 dilution |
| | is met. |

G) Culture Broth Plating (stock culture): After all dilutions were completed, a one (1) mL sample was withdrawn and placed on the whole plate agar. The liquid was gently swirled around in the whole plate and placed in the incubator at 37±2° C. for one hour turned upright (i.e., agar on bottom) to prevent the liquid from running out of the plate. For 23 additional hours or for a total of 24 hr incubation, plates were then turned up side down and incubated at 37±2° C.

H) Culture Broth Bacteria Enumeration: Plates were marked on the side so that counts could be taken from the bottom via marking with a pointed indelible ink pen. Plates containing 30-300 CFU's were counted and recorded as CFU count per one (1) mL broth culture. This range is typical for microbiology practices, is statistically more accurate, and is a range the human eye can read with the least chance for error. Values outside of <30 or >300 count range were not be recorded. Log₁₀ bacteria per mL of culture broth was determined.

The carcass source and preparation were as follows: Carcasses were purchased at a local retail store containing giblets. After removing the giblets, carcass weights were approximately 3.0-5.0 lbs (1361-2268 g). This weight range is within industry standards of processed weights commonly found in retail stores and should reflect a normal population of chicken carcasses found in the marketplace. Upon collection, all carcasses will be immediately placed in a cooler without ice and immediately transported approximately 20 miles to the laboratory. Upon arrival at the test facility, carcasses were refrigerated at 4-8° C. until carcass immersion. Carcasses were continually refrigerated until removed from the refrigerator within 6 hours prior to carcass bacteria spotting. Carcasses were then drained and wing banded for identification.

The carcass bacteria spotting techniques used were as follows: Four (4) to six (6) hours prior to bacteria spotting, carcasses were placed at ambient temperature. Carcasses were removed from the plastic bag within 15 minutes of bacteria spotting, drained in a wire basket for 5-10 minutes, and wing banded. After OD confirmation and stationary bacteria counts were reached, 25-35 minutes prior to carcass rinsing of each treatment, 10 carcasses were spotted with 10⁵ E. coli bacteria per carcass (total of two species equally administered). Actual bacteria counts were then enumerated.

Carcass bacteria were spotted by the following method: Using the bacteria stock solution as described above, all carcasses used were spotted along each breast feather track (6 per each track), legs (2 per each leg), and inside (4 spots inside cavity) with twenty 50-microliters with 10⁵ E. coli CFU per carcass. The applicator used was a repetitive pipettor (using tips that are 1.25 mL tip volume, 25 microliter increments, and a ±1.2% accuracy). Carcasses were placed flat to prevent liquid from running off the carcass, thus preventing loss of carcass bacteria. The surfaces spotted were not allowed to touch any object prior to carcass spraying.

After bacteria application, carcasses were placed on an open, covered laboratory bench and allowed to dry at ambient temperature for 25-35 minutes to represent time from defeathering, evisceration, and other commercial practices of processing to the time when carcasses enter the IOBW. During the drying process, the bacteria will have the opportunity to adhere to skin, thus simulating commercial poultry processing conditions.

The stock solutions used were made within two hours of Time 0 (carcass immersion). The procedure for preparing a DBDMH stock solution was as follows: add 10 g of DBDMH to each one (1) liter of sterile water and stir for 20±2 minutes. The stock solution will be passed through 200-mesh screen and filtered through a course filter (Fisher 09-790-14F, course porosity, fast flow rate, pleated). DBDMH Stock solution will be diluted as needed and Br₂ levels will be determined in triplicates, as described hereinafter. In the unlikely event that the DBDMH stock solution is cloudy or has small particles present, that indicates DBDMH powder has not been filtered properly, the stock solution will be reproduced and the old one discarded. For the sodium hypochlorite stock solution, concentrated sodium hypochlorite, commercial grade (Merck index 12,8773), was obtained from Aldrich. Stock solution Cl₂ levels were determined, as described hereinafter. Sodium hypochlorite stock solution was diluted as needed and Cl₂ was determined in triplicate.

Each stock solution was analyzed for Br₂ in triplicates by use of Hach Pocket Colorimeter test kit for Bromine (Hach Item Number 4670001) to verify bromine/chlorine concentration. DBDMH was analyzed and reported as Br₂. Sodium hypochlorite was analyzed as Br₂ and then converted to a Cl₂ basis by dividing by 2.25. Hach Colorimeter readings were confirmed using Chlorine Standard Solution Voluette Ampulet® by Hach. Also, two Hach Pocket Colorimeter test kits were compared to assure accuracy and consistency.

In conducting the washing operations with the test solutions, bromine and chlorine stock solutions, as needed, were administered into 6 liters of tap water for use in the sprayer system at the appropriate concentration levels. The spray system used was a common, handheld sprayer which simulated commercial carcass spraying techniques. The procedure involved the following:

A) Start Time Commencement: Treatment Group 1 (note Table 1) was sprayed and rinsed after the appropriate dripping time. Treatment Group 2 processing began approximately one hour after Treatment 1 began. This gave ample time for carcass bacteria spotting, carcass spraying, carcass rinsing, and other procedures necessary to complete Treatment 1. All treatments were started approximately one hour apart.

B) Control Treatment Carcasses Rinsed: For carcasses in the Group I treatment non-infected control group, carcasses were sprayed 25-35 minutes after spotting, allowed to drip for 30 seconds, then rinsed, using the whole bird rinse technique.

C) Spraying Procedure: Spraying included spraying on the outside of the bird, as well as administering 300 mL of the spray water into the inside of the carcass cavity and the water was then poured out of the carcass. The outside of the bird was sprayed as needed to ensure that the entire outside surface was wetted by the spray water.

D) Bromine/Chlorine Determination: After disinfectant stock solution addition to 6 liters on tap water for the spray system, a single water bromine or chlorine level, as applicable was determined prior to the commencement of spraying. Cl₂ was analyzed (as Br₂) and divided by 2.25 to convert the reading to an equivalent Cl₂ level. If a Br₂/Cl₂ level was not within acceptable limits (±20%), the sprayer water was abandoned and a new water source would be obtained and tested. This process would continue until an acceptable level is achieved.

The whole bird rinse procedures employed were in accordance with Federal, Register, Vol. 61, No. 144, Jul. 25, 1996, p. 38921 Pathogen Reduction: HACCP. Prior to carcass rinse initiation, sodium sulfite (8 mL of 1000 ppm solution) was equally added to the 400 mL Butterfield's Phosphate Diluent (BPD) solution to neutralize the effect of DBDMH and sodium hypochlorite. Carcasses were aseptically transferred to a sterile stomacher bag. BPD (400 mL) was poured directly to the internal cavity of each carcass contained in the sterile stomacher bag. The remaining “whole bird” rinse technique was followed as described in Federal Register. If the stomacher bag were to develop pin hole(s) due to sharp poultry bones or other unforeseen circumstances, the hole would be closed and sealed with a paper clip and rinsing would continue due to the fact that BPD has already been placed onto the carcass. The event would be recorded at an appropriate opportune time. The rinse solutions were transferred from each stomacher bag into sample bottles (completely labeled), refrigerated, and stored for plating after processing. Based upon statistically sound prior experience, plating of BPD solution occurred within 48 hours.

From the stomacher bag washings, E. Coli bacteria were determined and reported as total bacteria per 0.5 mL sample and the calculation made to determine counts per 400 mL stomacher bag content or per carcass.

The plating took place by dilution rates. Dilutions were completed within 48 hours of the sample being taken. Typical for microbiology procedures, a 10-fold dilution rate model was used for all carcasses as set forth in Table 3.

TABLE 3

| | |
|---|---|
| 1:1 (Sample taken “as is”) | From each of five (5) 16-mL test tubes will |
| 1:10 | be set up for each carcass, each tube will |
| 1:100 | contain 9 mL sterile water. One mL will be |
| 1:1,000 (1:1 K) | taken from the sample from the original |
| 1:10,000 (1:10 K) | carcass bottle and mixed with the first tube |
| 1:100,000 (1:100 K) | for a 1:10 dilution. One mL from this tube |
| | will be added to another for a 1:100 dilution, |
| | continuing the same procedure for all test |
| | tubes. |

After all dilutions are completed, a 0.5 mL sample was taken and placed on top of the half plate agar, including a 0.5 mL undiluted sample directly from the sample bottle representing a 1:1 dilution. Each half plate was marked on the plate's side with the appropriate dilution rates. The liquid was gently swirled around in the plate and placed in the incubator at 37±2° C. for one hour turned upright (i.e., agar on bottom) to prevent the liquid from running out of the plate. For 23 additional hours or for a total of 24 hr incubation, plates were then turned up side down and incubated at 37±2° C.

The dilution rate was re-adjusted to a total one mL sample to determine the total amount of CFU/mL and per carcass. Log₁₀ bacteria conversions per mL of BPD and per carcass were reported.

The results of these tests are summarized in Tables 4 and 5.

TABLE 4
E. COLI COUNT PER ML WASH FLUID AND NUMBER
CONTAINING NO BACTERIA

| | Average of 10 Carcasses | |
|---|---|---|
| Halogen¹ Level and Contact Time | Count per mL³ | Number of POS² |
| Br₂ (45 ppm), 30 sec | 17.8 a⁴ | 10/10 |
| Br₂ (75 ppm), 30 sec | 2.4 a | 5/10 |
| Br₂ (45 ppm), 60 sec | 7.8 a | 5/10 |
| Br₂ (75 ppm), 60 sec | 0.1 a | 1/10 |
| Cl₂ (20 ppm), 30 sec | 150.1 d | 10/10 |
| Cl₂ (50 ppm), 30 sec | 54.0 b | 10/10 |
| Cl₂ (20 ppm), 60 sec | 95.1 c | 10/10 |
| Cl₂ (50 ppm), 60 sec | 28.1 ab | 10/10 |

¹Br₂ source was DBDMH. Cl₂ source was sodium hypochlorite.
²Number of positive (POS) E. coli detected in wash fluid.
³Baseline average carcasses count among 10 carcasses were 4141 per mL wash fluid
⁴Means (i.e., numerical values) within a column without a common superscript are significantly different (P < 0.05) as determined by Least Significant Difference.

TABLE 5
CARCASS PIGMENTATION

Bacteria

| Carcass Pigmentation¹ | DBDMH² | NaOCl² |
|---|---|---|
| L = Lightness | 71.28 a⁴ | 70.36 a |
| a = Redness | (7.49) a | (7.68) a |
| b = Yellowness | 38.41 a | 39.06 a |
| Visual Color³ | 2.60 a | 2.40 a |
| Skin Bloating | None | None |
| Skin Browning | None | None |
| Skin Looseness | None | None |

¹Color Values generated with a Minolta Color Meter (Model DP-301)
²Bromine residual source was DBDMH. Chlorine residual source was sodium hypochlorite.
³Color Code (mean of all carcasses receiving each disinfectant): 0 = Complete carcass is white (either debarked or no yellow/red tint). 1 = Skin color is uneven or on slight yellow/red tint. 2 = Skin color is relatively even, with a max. of three debarked areas of <1″ diameter, carcass has moderate yellow/red tint. 3 = Skin color is very uniform & bright yellow/red.
⁴Means (i.e., numerical values) within a row without a common superscript are significantly different (P < 0.05) as determined by Least Significant Difference.

It can be seen that from the results in Table 1 that at each disinfectant level and contact time in the simulated IOBW treatment, E. coli were significantly reduced (P<0.05) with the use of DBDMH as the disinfectant as compared to NaOCl. Indeed, when using 75 ppm Br₂ from DBDMH, E. coli bacteria was nearly completely destroyed, especially at 60 see contact time, as compared to the other treatments. From the data in Table 5 it is clear that pigmentation was unaffected by the simulated IOBW treatment, and no other abnormal carcass signs were noted.

While this invention has been described in connection with treatment of poultry, the principles, materials, and methods described herein are applicable to treatment of other animal species processed for meat consumption either by humans or by pets, for example, such animals as cattle, swine, horses, sheep, bison, rabbit, camel, kangaroo, alligator, crocodile, and other such existing or potential sources of meat products.

Compounds referred to by chemical name or formula anywhere in this document, whether referred to in the singular or plural, are identified as they exist prior to coming into contact with another substance referred to by chemical name or chemical type (e.g., another component, a solvent, or etc.). It matters not what chemical changes, if any, take place in the resulting mixture or solution, as such changes are the natural result of bringing the specified substances together under the conditions called for pursuant to this disclosure. As an example, the phase “water treated with at least one 1,3-dihalo-5,5-dialkylhydantoin” and phrases of similar import signify that just before being brought into contact with an aqueous medium such as water, the at least one 1,3-dihalo-5,5-dialkylhydantoin referred to was the specified 1,3-dihalo-5,5-dialkylhydantoin. The phrase thus is not intended to suggest or imply that the chemical exists unchanged in the water. The transformations that take place are the natural result of bringing these substances together, and thus need no further elaboration.

Also, even though the claims may refer to substances in the present tense (e.g., “comprises”, “is”, etc.), the reference is to the substance as it exists at the time just before it is first contacted, blended or mixed with one or more other substances in accordance with the present disclosure.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

All documents referred to herein are incorporated herein by reference in toto as if fully set forth in this document.

This invention is susceptible to considerable variation within the spirit and scope of the appended claims.

That which is claimed is:

1. In the processing of poultry for consumption as a meat product, the improvement which comprises causing a eviscerated poultry carcass to be subjected to inside-outside washing with a microbiocidal solution of water treated with a microbiocidal amount of at least one 1,3-dibromo-5,5-dialkylhydantoin.

2. The improvement as in claim 1 wherein a mechanically transported series of poultry carcasses is automatically transported into apparatus in which the poultry carcass is subjected to said inside-outside washing.

3. The improvement as in claim 2 wherein in said inside-outside washing, the interior cavity of a transported poultry carcass is penetrated by a spray probe so that (i) contaminants together with (ii) microbiocidal water solution that is sprayed into the interior cavity of the poultry by the probe, drain from the carcass.

4. The improvement as in claim 3 wherein in said inside-outside washing, pressurized sprays of the microbiocidal water solution are applied to the exterior of the carcass so that the exterior of the carcass is thoroughly cleansed, and optionally the exterior of the carcass is also automatically mechanically scrubbed.

5. The improvement as in any of claims 1-4 wherein said at least one 1,3-dibromo-5,5-dialkylhydantoin consists essentially of 1,3-dibromo-5,5-dimethylhydantoin.

6. In the processing of poultry for consumption as a meat product, the improvement which comprises:
a) causing (i) at least one unopened defeathered poultry carcass and (ii) water treated with a microbiocidal amount of at least one 1,3-dibromo-5,5-dialkylhydantoin, to come into contact with each other, whereby the exterior of said carcass is wetted by such water for a period of time sufficient to provide microbiocidal activity on the wet exterior of said carcass via either spraying or washing,
b) opening and eviscerating the carcass that was wetted in a);
c) causing the opened and eviscerated poultry carcass to be subjected to inside-outside washing with water treated with a microbiocidal amount of at least one 1,3-dibromo-5,5-dialkylhydantoin.

7. The improvement as in claim 6 wherein the at least one defeathered poultry carcass in a) is one of a series of unopened defeathered poultry carcasses that are mechanically transported to a station where the poultry carcasses and the water treated with a microbiocidal amount of at least one 1,3-dibromo-5,5-dialkylhydantoin come into contact with each other, wherein a series of carcasses wetted in a) are mechanically transported to a station where in b) the series of carcasses are opened and eviscerated, and wherein in c) a series of poultry carcasses opened and eviscerated in b) is caused to be subjected to said inside-outside washing.

8. The improvement as in claim 7 wherein in said inside-outside washing, the interior cavity of a transported poultry carcass is penetrated by a spray probe which applies pressurized sprays of water treated with a microbiocidal amount of at least one 1,3-dibromo-5,5-dialkylhydantoin to the interior cavity of the carcass so that (i) contaminants together with (ii) water solution that is sprayed into the interior cavity of the poultry by the probe, drain from the carcass; and wherein in said inside-outside washing, pressurized sprays of water treated with a microbiocidal amount of at least one 1,3-dibromo-5,5-dialkylhydantoin are applied to the exterior of the carcass so that the exterior of the carcass is thoroughly cleansed, and optionally the exterior of the carcass is also automatically mechanically scrubbed.

9. The improvement as in claim 8 wherein the treated water sprayed into the interior cavity of the carcass has a higher concentration of active bromine than the concentration of active bromine in the treated water sprayed onto the exterior the carcass.

10. The improvement as in any of claims 6-9 wherein said at least one 1,3-dibromo-5,5-dialkylhydantoin consists essentially of 1,3-dibromo-5,5-dimethylhydantoin.

11. In the processing of poultry for consumption as a meat product, the improvement which comprises:
a) causing (i) water treated with a microbiocidal amount of at least one 1,3-dibromo-5,5-dialkylhydantoin and (ii) at least one defeathered poultry carcass to come into contact with each other before the carcass is opened, whereby the carcass exterior is wetted by such water for a period of time sufficient to provide microbiocidal activity of the wet exterior of the carcass via either spraying or washing;
b) opening and eviscerating the carcass that was wetted in a);
c) causing the eviscerated carcass to be subjected to inside-outside washing with water treated with a microbiocidal amount of at least one 1,3-dibromo-5,5-dialkylhydantoin; and
d) causing the carcass that was washed in c) to be placed in a chill tank and brought into contact with chill water treated with a microbiocidal amount of at least one 1,3-dibromo-5,5-dialkylhydantoin, said carcass being in said chill water for a period of time that is at least sufficient for the carcass to reach a preselected low temperature.

12. The improvement as in claim 11 wherein to cause the contacting in a), water treated with a microbiocidal amount of at least one 1,3-dibromo-5,5-dialkylhydantoin is sprayed on said defeathered poultry carcass.

13. The improvement as in claim 11 wherein to cause the contacting in a), said defeathered poultry carcass is immersed in water treated with a microbiocidal amount of at least one 1,3-dibromo-5,5-dialkylhydantoin.

14. The improvement as in claim 11 wherein the washing in c) is effected by use of a hand-operated sprayer.

15. The improvement as in claim 11 wherein the washing in c) is effected by use of an inside-outside washing apparatus through which the carcass is conveyed.

16. The improvement as in claim 15 wherein said washing apparatus comprises a spray delivery system adapted to apply treated water to the interior cavity of said carcass and another spray delivery system adapted to apply treated water to the exterior of said carcass.

17. The improvement as in claim 16 wherein the treated water applied by the spray delivery system to the interior cavity of said carcass is treated with a higher concentration of the at least one 1,3-dibromo-5,5-dialkylhydantoin than the concentration of the at least one 1,3-dibromo-5,5-dialkylhydantoin used in the treated water applied by the spray delivery system to the exterior said carcass.

18. The improvement as in claim 11 wherein to cause the contacting in a), water treated with a microbiocidal amount of at least one 1,3-dibromo-5,5-dialkylhydantoin is sprayed on said defeathered poultry carcass; and wherein the washing in c) is effected by use of a hand-operated sprayer.

19. The improvement as in claim 11 wherein to cause the contacting in a), water treated with a microbiocidal amount of at least one 1,3-dibromo-5,5-dialkylhydantoin is sprayed on said defeathered poultry carcass; and wherein the washing in c) is effected by use of an inside-outside washing apparatus through which the carcass is conveyed.

20. The improvement as in claim 19 wherein said washing apparatus comprises a spray delivery system adapted to apply treated water to the interior cavity of said carcass and another spray delivery system adapted to apply treated water to the exterior of said carcass.

21. The improvement as in claim 20 wherein the treated water applied by the spray delivery system to the interior cavity of said carcass is treated with a higher concentration of the at least one 1,3-dibromo-5,5-dialkylhydantoin than the concentration of the at least one 1,3-dibromo-5,5-dialkylhydantoin used in the treated water applied by the spray delivery system to the exterior said carcass.

22. The improvement as in any of claims 11, 15, 17, 19, or 20 wherein said at least one 1,3-dibromo-5,5-dialkylhydantoin consists essentially of 1,3-dibromo-5,5-dimethylhydantoin.

23. In the slaughter and processing of poultry as a meat product, the improvement which comprises:
a) causing (i) water treated with a microbiocidal amount of at least one 1,3-dibromo-5,5-dialkylhydantoin and (ii) at least one unopened defeathered poultry carcass to come into contact with each other before the carcass is opened, whereby the carcass exterior is wetted by such water for a period of time sufficient to provide microbiocidal activity of the wet exterior of the carcass;
b) opening and deviscerating the carcass that was wetted in a);
c) causing the deviscerated carcass to be subjected to inside-outside washing with water treated with a microbiocidal amount of at least one 1,3 -dibromo-5,5-dialkylhydantoin;
d) causing the carcass that was washed in c) to be placed in a chill tank and brought into contact with chill water treated with a microbiocidal amount of at least one 1,3-dibromo-5,5-dialkylhydantoin, said carcass being in said chill water for a period of time that is at least sufficient for the carcass to reach a preselected low temperature;
e) causing the chilled carcass to be removed from the chill tank; and
f) before packaging the chilled carcass, causing (i) the chilled carcass and (ii) water treated with a microbiocidal amount of at least one 1,3-dibromo-5,5-dialkylhydantoin to come into contact with each other.

24. The improvement as in claim 23 wherein to cause the contacting in f), water treated with a microbiocidal amount of at least one 1,3-dibromo-5,5-dialkylhydantoin is sprayed on said chilled carcass.

25. The improvement as in claim 23 wherein to cause the contacting in f), said chilled carcass is immersed in the water treated with a microbiocidal amount of at least one 1,3 -dibromo-5,5-dialkylhydantoin.

26. The improvement as in claim 24 wherein the washing in c) is effected by use of a hand-operated sprayer.

27. The improvement as in claim 24 wherein the washing in c) is effected by use of an inside-outside washing apparatus through which the carcass is conveyed.

28. The improvement as in claim 27 wherein said washing apparatus comprises a spray delivery system adapted to apply treated water to the interior cavity of said carcass and another spray delivery system adapted to apply treated water to the exterior of said carcass.

29. The improvement as in claim 28 wherein the treated water applied by the spray delivery system to the interior cavity of said carcass is treated with a higher concentration of the at least one 1,3-dibromo-5,5-dialkylhydantoin than the concentration of the at least one 1,3-dibromo-5,5-dialkylhydantoin used in the treated water applied by the spray delivery system to the exterior said carcass.

30. The improvement as in claim 24 wherein to cause the contacting in a), water treated with a microbiocidal amount of at least one 1,3-dibromo-5,5-dialkylhydantoin is sprayed on said defeathered poultry carcass, and wherein the washing in c) is effected by use of a hand-operated sprayer.

31. The improvement as in claim 24 wherein to cause the contacting in a), water treated with a microbiocidal amount of at least one 1,3-dibromo-5,5-dialkylhydantoin is sprayed on said defeathered poultry carcass, and wherein the washing in c) is effected by use of an inside-outside washing apparatus through which the carcass is conveyed.

32. The improvement as in claim 31 wherein said washing apparatus comprises a spray delivery system adapted to apply treated water to the interior cavity of said carcass and another spray delivery system adapted to apply treated water to the exterior of said carcass.

33. The improvement as in claim 32 wherein the treated water applied by the spray delivery system to the interior cavity of said carcass is treated with a higher concentration of the at least one 1,3-dibromo-5,5-dialkylhydantoin than the concentration of the at least one 1,3-dibromo-5,5-dialkylhydantoin used in the treated water applied by the spray delivery system to the exterior said carcass.

34. The improvement as in any of claims 23, 27, 32, or 33 wherein said at least one 1,3-dibromo-5,5-dialkylhydantoin consists essentially of 1,3-dibromo-5,5-dimethylhydantoin.

35. The improvement as in claim 25 wherein the washing in c) is effected by use of a hand-operated sprayer.

36. The improvement as in claim 25 wherein the washing in c) is effected by use of an inside-outside washing apparatus through which the carcass is conveyed.

37. The improvement as in claim 36 wherein said washing apparatus comprises a spray delivery system adapted to apply treated water to the interior cavity of said carcass and another spray delivery system adapted to apply treated water to the exterior of said carcass.

38. The improvement as in claim 37 wherein the treated water applied by the spray delivery system to the interior cavity of said carcass is treated with a higher concentration of the at least one 1,3-dibromo-5,5-dialkylhydantoin than the concentration of the at least one 1,3-dibromo-5,5-dialkylhydantoin used in the treated water applied by the spray delivery system to the exterior said carcass.

39. The improvement as in claim 25 wherein to cause the contacting in a), water treated with a microbiocidal amount of at least one 1,3-dibromo-5,5-dialkylhydantoin is sprayed on said defeathered poultry carcass, and wherein the washing in c) is effected by use of a hand-operated sprayer.

40. The improvement as in claim 25 wherein to cause the contacting in a), water treated with a microbiocidal amount of at least one 1,3-dibromo-5,5-dialkylhydantoin is sprayed on said defeathered poultry carcass; and wherein the washing in c) is effected by use of an inside-outside washing apparatus through which the carcass is conveyed.

41. The improvement as in claim 40 wherein said washing apparatus comprises a spray delivery system adapted to apply treated water to the interior cavity of said carcass and another spray delivery system adapted to apply treated water to the exterior of said carcass.

42. The improvement as in claim 41 wherein the treated water applied by the spray delivery system to the interior cavity of said carcass is treated with a higher concentration of the at least one 1,3-dibromo-5,5-dialkylhydantoin than the concentration of the at least one 1,3-dibromo-5,5-dialkylhydantoin used in the treated water applied by the spray delivery system to the exterior said carcass.

43. The improvement as in any of claims 36, 38, or 42 wherein said at least one 1,3-dibromo-5,5-dialkylhydantoin consists essentially of 1,3-dibromo-5,5-dimethylhydantoin.

44. The improvement as in claim 23 wherein to cause the contacting in a) said defeathered poultry carcass is caused to travel through a body of water treated with at least one 1,3-dibromo-5,5-dialkylhydantoin while immersed in said body of water.

45. The improvement as in claim 44 wherein said washing apparatus comprises a spray delivery system adapted to apply treated water to the interior cavity of said carcass and another spray delivery system adapted to apply treated water to the exterior of said carcass.

46. The improvement as in claim 45 wherein the treated water applied by the spray delivery system to the interior cavity of said carcass is treated with a higher concentration of the at least one 1,3-dibromo-5,5-dialkylhydantoin than the concentration of the at least one 1,3-dibromo-5,5-dialkylhydantoin used in the treated water applied by the spray delivery system to the exterior said carcass.

47. The improvement as in any of claims 44-46 wherein said at least one 1,3-dibromo-5,5-dialkylhydantoin consists essentially of 1,3-dibromo-5,5-dimethylhydantoin.

48. In the processing of poultry for consumption as a meat product, the improvement which comprises:
A) causing an eviscerated poultry carcass to be subjected to inside-outside washing with a microbiocidal solution of water treated with a microbiocidal amount of at least one 1,3-dibromo-5,5-dialkylhydantoin; and
B) causing the carcass that was washed in A) to be placed in a chill tank and brought into contact with chill water treated with a microbiocidal amount of at least one 1,3-dibromo-5,5-dialkylhydantoin, said carcass being in said chill water for a period of time that is at least sufficient for the carcass to reach a preselected low temperature.

49. The improvement as in claim 48 wherein a mechanically transported series of poultry carcasses is automatically transported into apparatus in which the poultry carcass is subjected to said inside-outside washing.

50. The improvement as in claim 49 wherein in said inside-outside washing, the interior cavity of a transported poultry carcass is penetrated by a spray probe so that (i) contaminants together with (ii) microbiocidal water solution that is sprayed into the interior cavity of the poultry by the probe, drain from the carcass.

51. The improvement as in claim 50 wherein in said inside-outside washing, pressurized sprays of the microbiocidal water solution are applied to the exterior of the carcass so that the exterior of the carcass is thoroughly cleansed, and optionally the exterior of the carcass is also automatically mechanically scrubbed.

52. The improvement as in any of claims 48-51 wherein said at least one 1,3-dibromo-5,5-dialkylhydantoin consists essentially of 1,3-dibromo-5,5-dimethylhydantoin.
